(19) United States
(12) Patent Application Publication
(10) Pub. No.: US 2014/0368305 A1
(43) Pub. Date: Dec. 18, 2014

(54) INDUCTOR STRUCTURE

(71) Applicant: YI-TAI CHAO, Taichung City (TW)

(72) Inventor: YI-TAI CHAO, Taichung City (TW)

(21) Appl. No.: 14/107,390

(22) Filed: Dec. 16, 2013

(30) Foreign Application Priority Data
Jun. 14, 2013 (TW) 102211076

(51) Int. Cl. H01F 27/04

(52) U.S. Cl. CPC H01F 27/04
USPC 336/90

(57) ABSTRACT

An inductor structure includes a powder core sinter, a coil, and a coating body. The powder core sinter includes a base and a convex column. The convex column is arranged on the base, so that the powder core sinter is in inverse T-shaped. An accommodation space is formed on the base and around the convex column. The coil includes a coiling body wrapping the convex column and being arranged in the accommodation space. The coiling body includes two electrode pins extended to lateral sides of the base. The coating body includes a fillister in inverse T-shaped. The fillister accommodates the powder core sinter and the coil. The coating body fully covers the powder core sinter and the coil except the two electrode pins extended outside of the coating body. The inductor structure has high current resistance and high heat resistance, and avoids the current leakage phenomenon.

### BACKGROUND OF THE INVENTION

1. Field of the Invention

The present invention relates to an inductor, and especially relates to an inductor structure with high current resistance and high heat resistance.

2. Description of the Related Art

An inductor is a passive electronic element with character of resisting rushing current changes. The inductor includes an iron core wound by a coil. The iron core is made of magnetic material or non-magnetic material. The magnetic flux of the inductor is changed because the current in the coil is changed. The inductor is an electronic element that forms the magnetic field, wherein the magnetic field is formed due to the variation of the current in the coil. The alternating current forms the magnetic field while the current is induced by the variation of the magnetic field. The inductor has an inductance determined by the linear relationship between the current and the magnetic field.

A traditional inductor includes an iron core made of manganese-zinc ferrite in I-shape. The iron core is wound by a coil, and then assembled to a U-shaped cover. The magnetic permeability of the traditional inductor is high, and the saturation magnetic is low. Therefore, it is saturated easily, and cannot resist high current. The traditional inductor is not used now.

A conventional inductor, such as a reactor or a choke, has high current resistance. The conventional inductor is made of suppressed powder. Firstly, a coil is arranged into a mold. Then, the iron powder is poured into the mold. Finally, the coil and the iron powder are suppressed as the conventional inductor. The magnetic permeability of the conventional inductor is low, and the saturation magnetic is high. Therefore, it is not saturated easily, and can resist high current.

Similar to the conventional inductor mentioned above, another conventional inductor is made of iron powder with polymer colloid. This kind of conventional inductor is made by suppressing six to eight tons force per square centimeter. However, the insulating paint of the coil has risk of breakage due to the high suppression. Therefore, the layers of the coil are short circuit, and the current is rising rapidly.

Still another conventional inductor is made of iron-chromium-silicon (FeCrSi) powder. Firstly, the iron-chromium-silicon powder is heat-suppressed as a base with a pillar. Then, the pillar is wrapped by a coil. Finally, the iron-chromium-silicon powder is heat-suppressed covering the coil and the pillar, but the base is not covered. This kind of conventional inductor has the current leakage phenomenon easily.

Still another conventional inductor is introduced as follows. Firstly, a coil and a lead frame are arranged into a mold. Secondly, the iron powder is poured into the mold and then molding. Finally, it is heat-suppressed. However, the procedures of this kind of conventional inductor are complex and the working time is longer because it has more components.

### SUMMARY OF THE INVENTION

In order to solve the above-mentioned problems, an object of the present invention is to provide an inductor structure made by a mix method comprising thermal setting, sintering and injection. The inductor structure has high current resistance and high heat resistance. A coil and a powder core sinter are covered by a coating body to avoid the current leakage phenomenon. The iron loss of the present invention is lower than the iron loss of the conventional iron powder molding due to the mix method.

In order to achieve the object of the present invention mentioned above, the inductor structure includes a powder core sinter, a coil, and a coating body. The powder core sinter includes a base, a convex column and an accommodation space. The convex column is arranged on the base, so that the powder core sinter is in inverse T-shaped. The accommodation space is formed on the base and around the convex column. The coil includes a coiling body. The coiling body wraps the convex column and is arranged in the accommodation space. The coiling body includes two electrode pins extended to lateral sides of the base. The coating body includes a fillister in inverse T-shaped. The fillister accommodates the powder core sinter and the coil. The coating body fully covers the powder core sinter and the coil except the two electrode pins extended outside of the coating body.

Moreover, the powder core sinter is made of ferrosilicon (FeSi) powder. The magnetic permeability of the powder core sinter is 60. The coil is made of copper wires. The two electrode pins are extended outside of corners of the coating body. The coating body is made of stainless steel. The stainless steel is made of iron-chromium-silicon (FeCrSi). The magnetic permeability of the stainless steel is between 14 and 18. The direct current resistance of the inductor structure is low (about 0.72 mohm).

### BRIEF DESCRIPTION OF DRAWING

FIG. 1 shows a flow chart for manufacturing the inductor structure of the present invention.

FIG. 2 shows a schematic diagram of the powder core sinter of the inductor structure of the present invention.

FIG. 3 shows a schematic diagram of the powder core sinter and the coil of the present invention.

FIG. 4 shows a cutaway view of the inductor structure of the present invention.

FIG. 5 shows a perspective view of the inductor structure of the present invention.

### DETAILED DESCRIPTION OF THE INVENTION

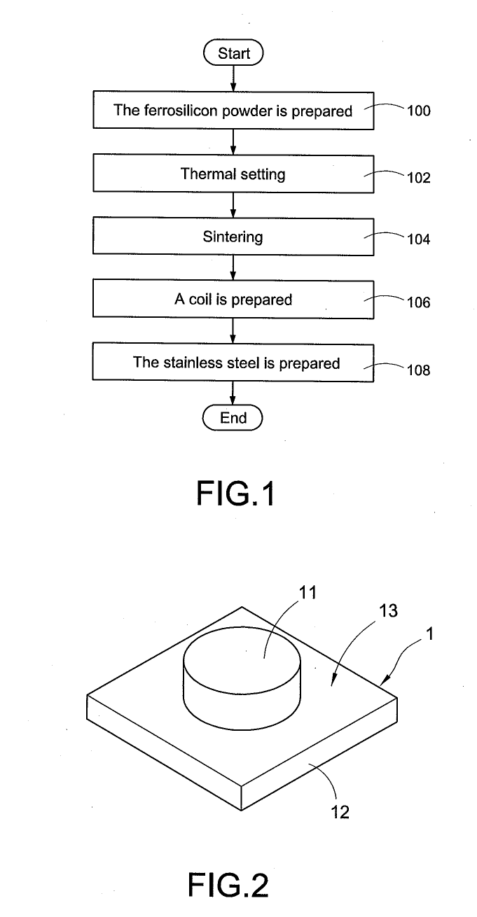

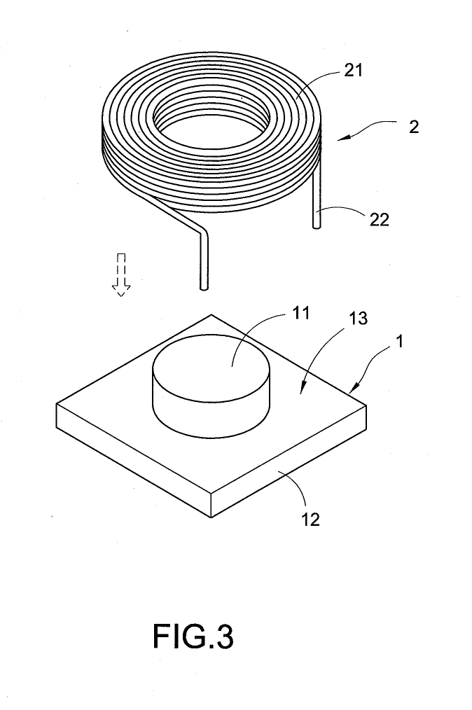

FIG. 1 shows a flow chart for manufacturing the inductor structure of the present invention. FIG. 2 shows a schematic diagram of the powder core sinter of the inductor structure of the present invention. FIG. 3 shows a schematic diagram of the powder core sinter and the coil of the present invention. Step 100: the ferrosilicon (FeSi) powder is prepared.

Step 102: the ferrosilicon powder is thermal set and is suppressed as a powder core in inverse T-shaped.

Step 104: the powder core is sintered in low temperature to become a powder core sinter 1. The powder core sinter 1 includes a base 12, a convex column 11 and an accommodation space 13. The convex column 11 is arranged on the base 12. The accommodation space 13 is formed on the base and around the convex column 11. The magnetic permeability of the powder core sinter 1 is 60 according to the sintering process.

Step 106: a coil 2 is prepared. The convex column 11 is wrapped by a coiling body 21 of the coil 2 (as shown in FIG. 3). Two electrode pins 22 of the coiling body 21 are extended to corners of lateral sides of the base 12. The coil 2 is made of copper wires.

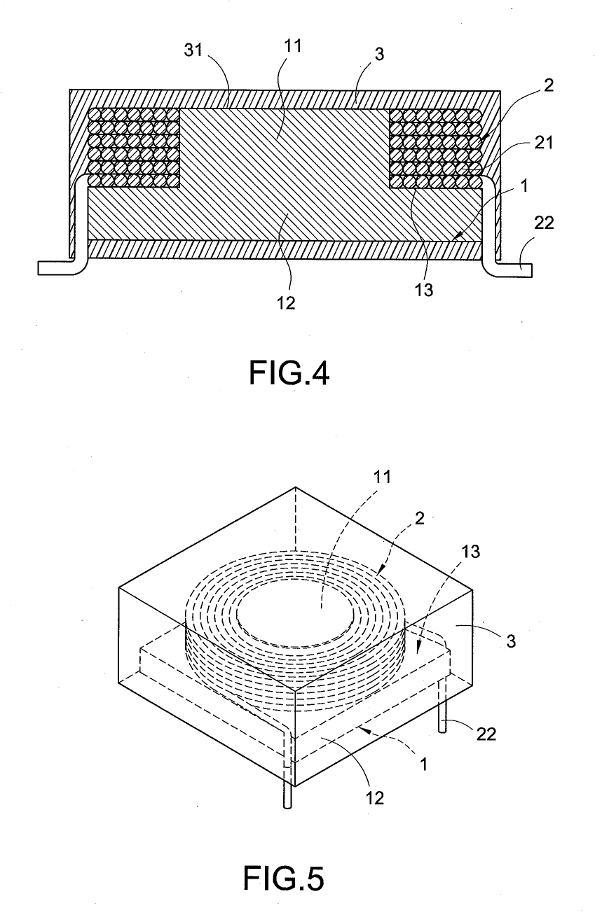

Step 108: the stainless steel is prepared. The powder core sinter 1 wrapped by the coil 2 is arranged into a mold (not shown in FIG. 1, FIG. 2 or FIG. 3). According to the metal injection molding process, the stainless steel is injected molding as a coating body 3 covering the powder core sinter 1 and the coil 2 (as shown in FIG. 4). The two electrode pins 22 are extended outside of corners of the coating body 3. The two electrode pins 22 are electrically connected to a printed circuit board (not shown in FIG. 1, FIG. 2 or FIG. 3). The stainless steel is made of iron-chromium-silicon (FeCrSi), wherein the magnetic permeability of the iron-chromium-silicon is between 14 and 18.

The magnetic permeability of the powder core sinter 1 is 60 according to the ferrosilicon powder sinter process. The iron loss of the coil 2 is lower than the iron loss of the conventional iron powder molding because the turn number of the coil 2 is less and the magnetic permeability is higher. The direct current resistance is low (about 0.72 mohm). Therefore, the current is small, and the inductor structure has high current resistance and high heat resistance. Moreover, the coating body 3 fully covers the powder core sinter 1 and the coil 2 (except the two electrode pins 22) to avoid the current leakage phenomenon.

FIG. 4 shows a cutaway view of the inductor structure of the present invention. FIG. 5 shows a perspective view of the inductor structure of the present invention. An inductor structure includes a powder core sinter 1, a coil 2, and a coating body 3.

The powder core sinter 1 includes a base 12, a convex column 11 and an accommodation space 13. The convex column 11 is arranged on the base 12, so that the powder core sinter 1 is in inverse T-shaped. The accommodation space 13 is formed on the base 12 and around the convex column 11. The powder core sinter 1 is made of ferrosilicon (FeSi) powder, wherein the magnetic permeability of the ferrosilicon powder is 60.

The coil 2 includes a coiling body 21. The coiling body 21 wraps the convex column 11 and is arranged in the accommodation space 13. The coiling body 21 includes two electrode pins 22 extended to corners of lateral sides of the base 12. The coil 2 is made of copper wires.

The coating body 3 includes a fillister 31 in inverse T-shaped. The fillister 31 accommodates the powder core sinter 1 and the coil 2. The coating body 3 fully covers the powder core sinter 1 and the coil 2 except two electrode pins 22 extended outside of corners of the coating body 3 to avoid the current leakage phenomenon. The two electrode pins 22 are electrically connected to a printed circuit board (not shown in FIG. 4 or FIG. 5). The coating body 3 is made of stainless steel. The stainless steel is made of iron-chromium-silicon (FeCrSi), wherein the magnetic permeability of the iron-chromium-silicon is between 14 and 18.

The magnetic permeability of the powder core sinter 1 is 60 according to the ferrosilicon powder sinter process. The lap number of the coil 2 is less due to high magnetic permeability. The iron loss of the coil 2 is lower than the iron loss of the conventional iron powder molding. The direct current resistance is low (about 0.72 mohm). Therefore, the current is small, and the inductor structure has high current resistance and high heat resistance.

Although the present invention has been described with reference to the preferred embodiment thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. An inductor structure comprising:
a powder core sinter having inverse T-shape and comprising a base, a convex column and an accommodation space, the convex column arranged on the base, the accommodation space formed on the base and around the convex column;
a coil comprising a coiling body wrapping the convex column and arranged in the accommodation space, the coiling body comprising two electrode pins extended to the base; and
a coating body comprising a fillister of inverse T-shape, the fillister accommodating the powder core sinter and the coil, the coating body fully covering the powder core sinter and the coil except the two electrode pins extended outside of the coating body.

2. The inductor structure in claim 1, wherein the powder core sinter is made of ferrosilicon (FeSi) powder.

3. The inductor structure in claim 2, wherein a magnetic permeability of the powder core sinter is 60.

4. The inductor structure in claim 3, wherein the coil is made of copper wires.

5. The inductor structure in claim 4, wherein the two electrode pins are extended at corners of the coating body.

6. The inductor structure in claim 5, wherein the coating body is made of stainless steel; the stainless steel is made of iron-chromium-silicon (FeCrSi).

7. The inductor structure in claim 6, wherein a magnetic permeability of the stainless steel is between 14 and 18.

8. The inductor structure in claim 7, wherein the direct current resistance of the inductor structure is 0.72 mohm.
